(19) United States
(12) Patent Application Publication
(10) Pub. No.: US 2015/0073968 A1
(43) Pub. Date: Mar. 12, 2015

(54) FLOWBOOK ALTERNATIVE TRADING SYSTEM

(71) Applicant: Knight Capital Group, INC, CHICAGO, IL (US)

(72) Inventor: Michael LeRoy Blum, Western Springs, IL (US)

(73) Assignee: Knight Capital Group, INC, CHICAGO, IL (US)

(21) Appl. No.: 14/374,904

(22) PCT Filed: Jan. 25, 2013
(86) PCT No.: PCT/US2013/023245

§ 371 Date: Jul. 26, 2014

Related U.S. Application Data
(60) Provisional application No. 61/591,825, filed on Jan. 27, 2012.

(51) Int. Cl. G06Q 40/04

(52) U.S. Cl. CPC G06Q 40/04
USPC 705/37

(57) ABSTRACT

An alternative trading system or platform for allowing a liquidity remover to place an order for the purchase or sale of a security or other commodity to be fulfilled by one or more liquidity providers. The platform may contain a rating module to allow members to create ratings of one another based on their own criteria; an indexor which utilizes the ratings to generate a list of liquidity providers offering a security of interest to a liquidity remover; a provider selector for determining which provider or providers to join in a transaction with the remover; and a price calculator for determining an execution price for the current transaction between a remover and a provider based on ratings and payment/price improvement configurations.

### CROSS REFERENCE

This application claims the benefit of priority to U.S. Provisional Application 61/591,825, filed Jan. 27, 2012, the contents of which are incorporated by reference in their entirety.

### BACKGROUND

On a public exchange, trades are arranged according to strict priority rules and traders cannot choose or know their trading counterparties. As a result, certain traders known as liquidity providers (also referred to as market makers) are prevented from differentiating among customers based on their experience and are subject to adverse selection when they trade with better-informed traders with whom they do not wish to trade. Because liquidity providers must make an equal market to all participants on a public exchange, they must make a market to the lowest common denominator of liquidity removers by whom they may be adversely selected. This greatly disadvantages the holders of the most valuable order flow—the retail firms. As a result, retail firms and market makers have established direct trading relationships away from the public exchanges, where the liquidity provider can provide a unique market to each of its chosen retail partners, which is often tighter and for greater size than what the liquidity provider can provide on a public exchange. In addition, the matching algorithm employed can be more sophisticated, sub-penny execution prices may be provided and unique fee or rebate structures may be arranged. The ability to choose one's customers, know one's customers and have freedom over pricing, size, fees and payments and have control over one's information allows both sides of the transaction to benefit through improved price, improved size and lower execution costs.

In response to this dynamic, more order flow is moving off public exchanges and into direct market making relationships or into certain types of alternative trading systems called dark pools. This trend has increased fragmentation of the equity markets, where trading splinters among various discrete market centers and orders sent to one market center do not interact with orders sent to other market centers. Greater fragmentation has increased the complexity, costs and resources associated with trading while at the same time reducing transparency to the other market participants.

At any given time, a security has a price at which the market is willing to purchase the security (national best bid or NBB), and a price at which the market is willing to sell the security (national best offer or NBO). Together, the national best bid and national best offer form the “NBBO” and the difference between the two prices is the spread. In some cases, a liquidity provider might be willing to interact with and provide better pricing than reflected in the NBBO to a particular remover, if it could rapidly determine the transaction would likely be advantageous. A system and method for providing that determination are provided.

### SUMMARY

In some configurations, an improved alternative trading system is provided where liquidity removers and liquidity providers can more efficiently transact with one another. In such configurations, the trading platform may allow a liquidity provider to offer varying degrees of liquidity to certain removers at better pricing than the national best bid or national best offer shown on a public exchange. In some configurations, the trading platform may configured to take advantage of the spread between the national best bid and national best offer to provide removers with a better price than they might achieve with prior art trading platforms, while allowing providers an opportunity to give pricing discounts to preferred removers.

Some configurations of the trading platform may also provide a way to aggregate the liquidity from multiple liquidity providers into a single pool of liquidity while at the same time allowing each liquidity provider to know their customer and make a unique market to each customer (remover). For example, a liquidity provider might differentiate between two known customers based on its experience with those customers with respect to one or more of the following: share price; number of shares; price improvement relative to the NBBO; and fees/rebates. In such an example, the trading platform may attempt to have all of the know-your-customer benefits of a direct trading relationship without sacrificing the liquidity and other advantages offered by multilateral public exchanges.

The trading platform may also in some configurations provide the remover with the ability the specify a lump sum payment percentage and a per share price improvement percentage.

### BRIEF DESCRIPTION

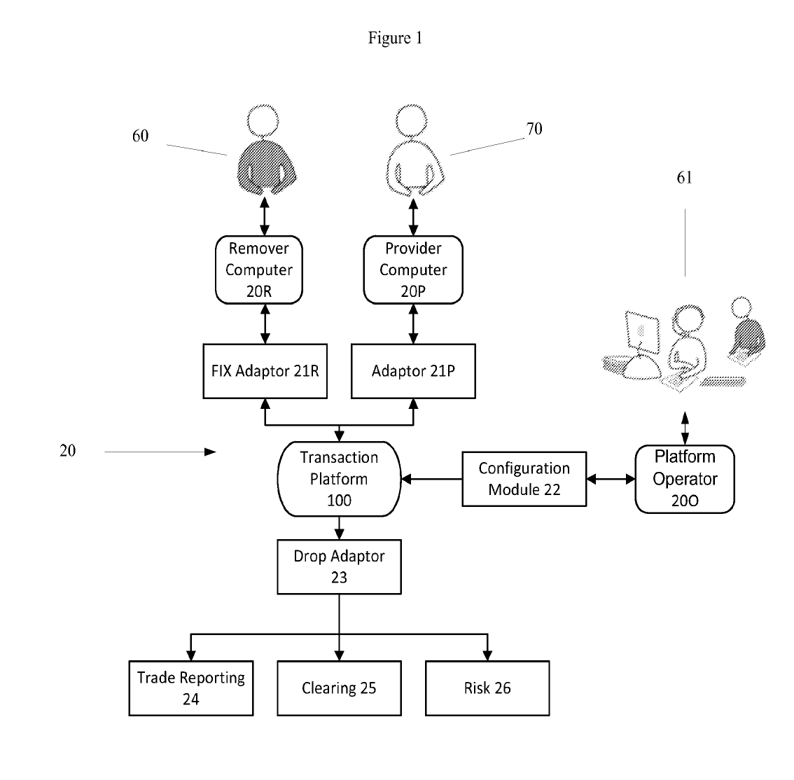

FIG. 1 shows a high level schematic diagram of a trading system.

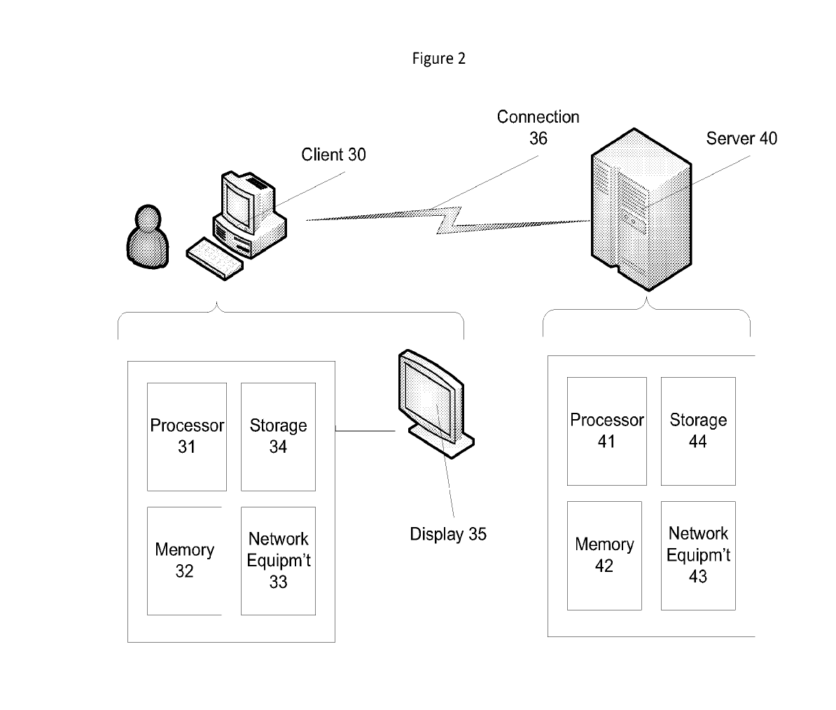

FIG. 2 shows a schematic of a client server model.

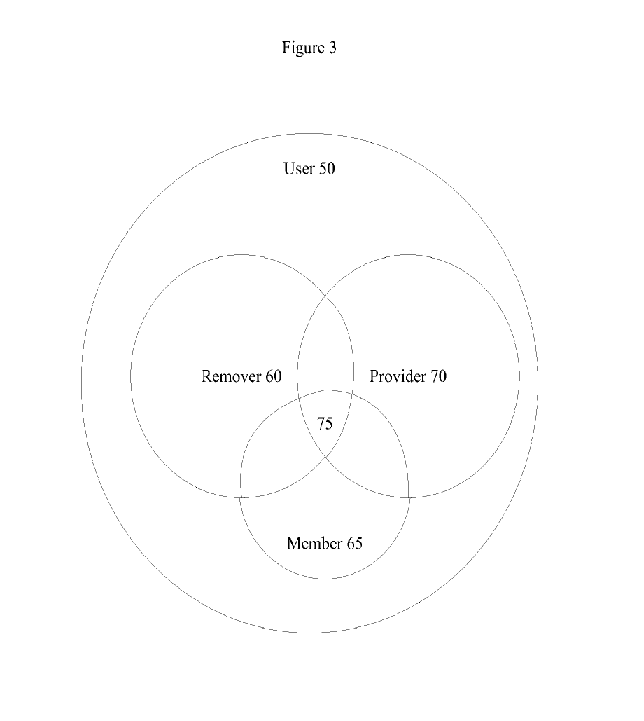

FIG. 3 shows a Venn diagram of users, members, providers, and removers.

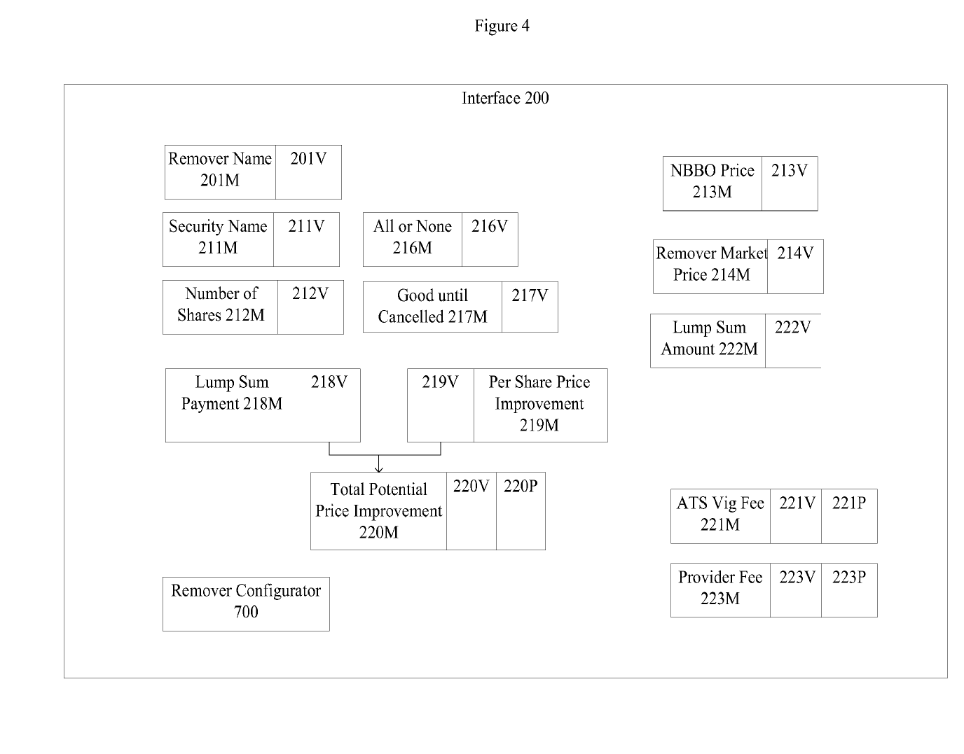

FIG. 4 shows a schematic of an interface for the remover.

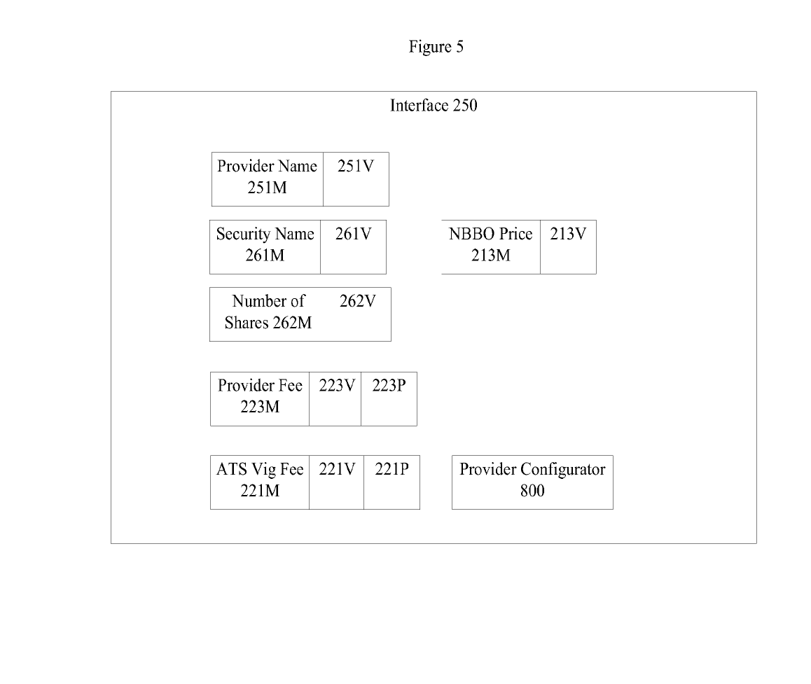

FIG. 5 shows a schematic of an interface for the provider.

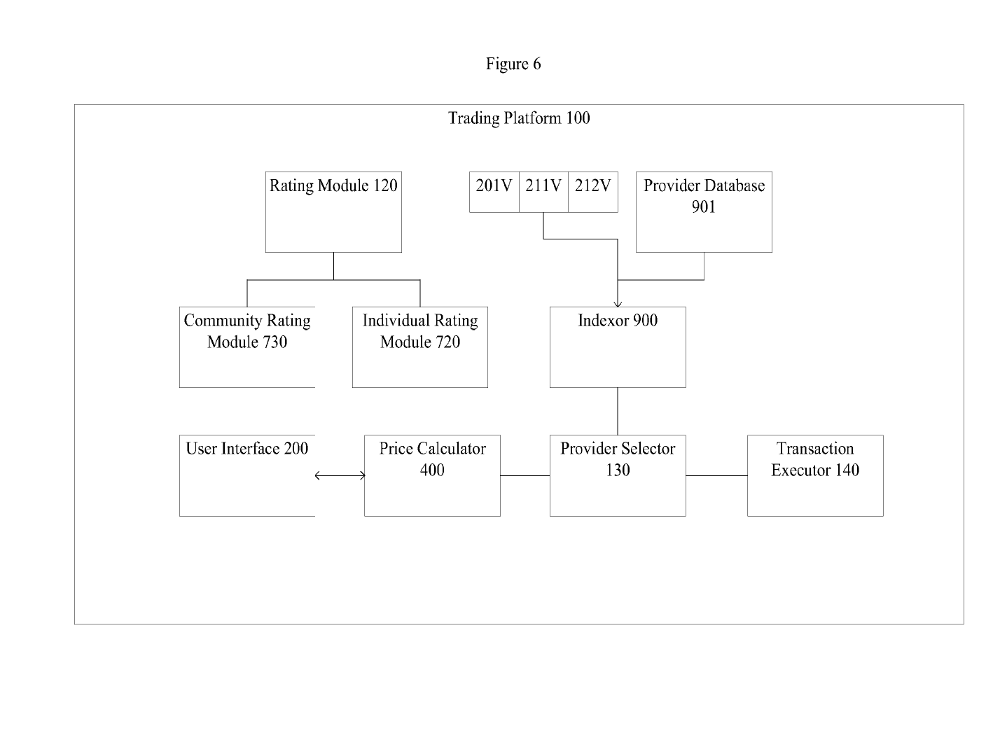

FIG. 6 shows a schematic of the trading platform.

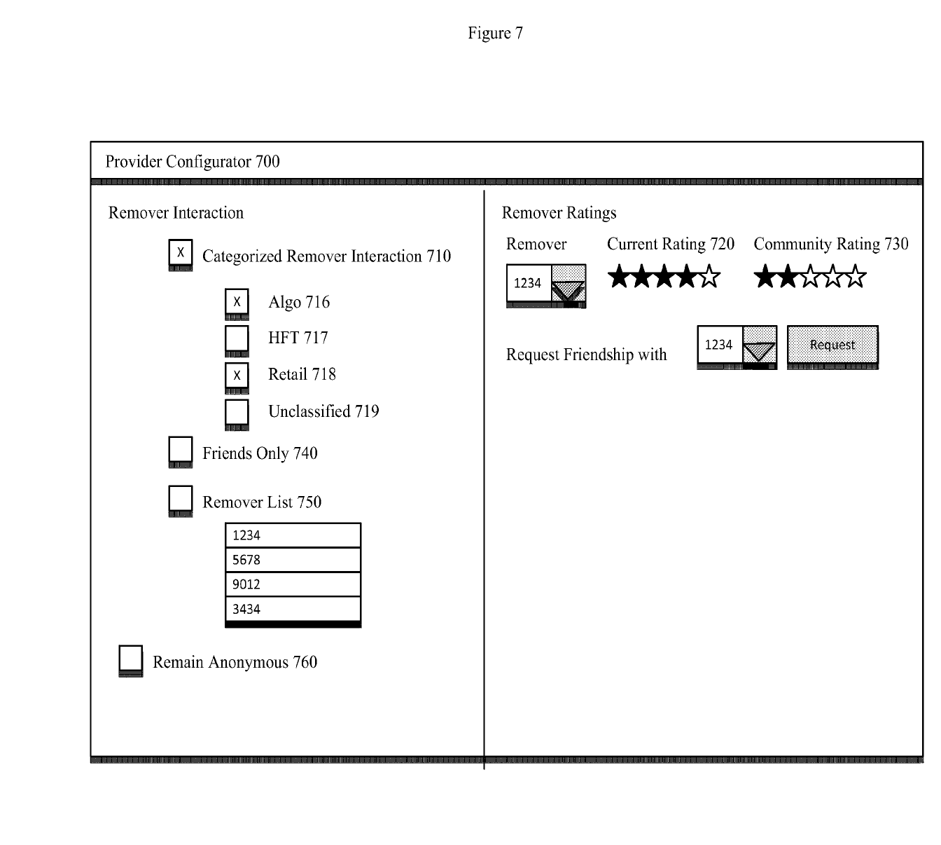

FIG. 7 shows a sample screenshot of the provider configurator.

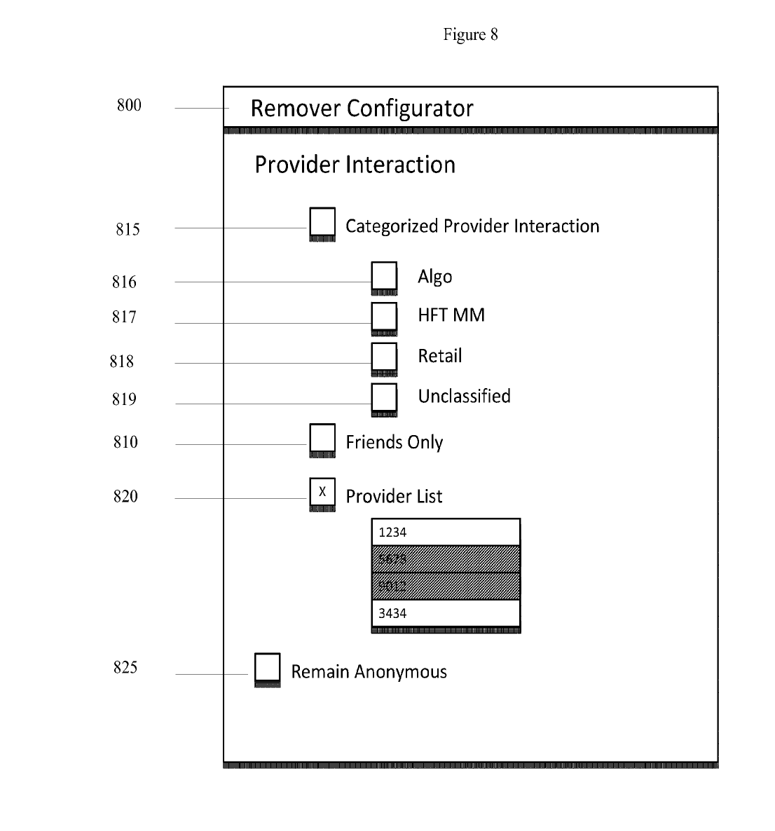

FIG. 8 shows a sample screenshot of the remover configurator.

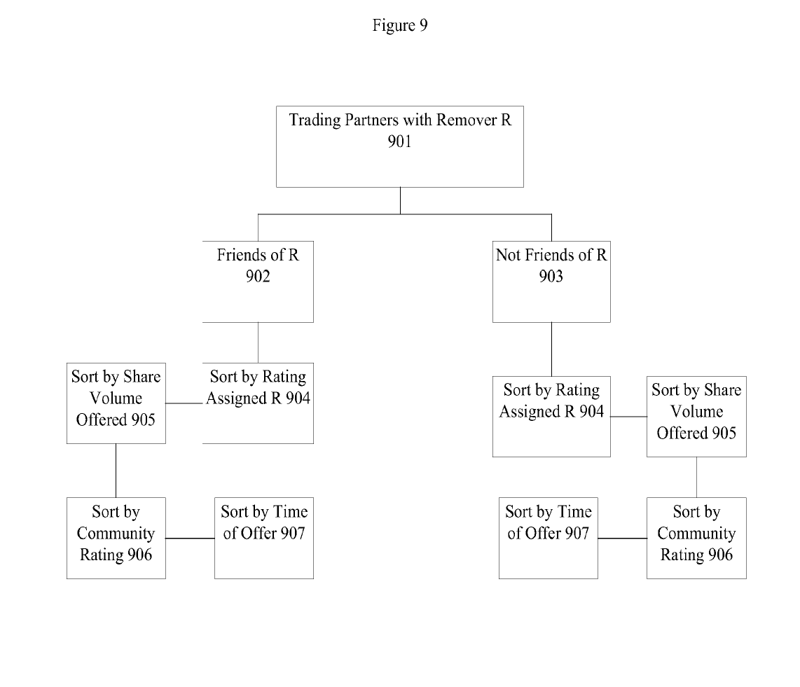

FIG. 9 shows a flow diagram of the indexor.

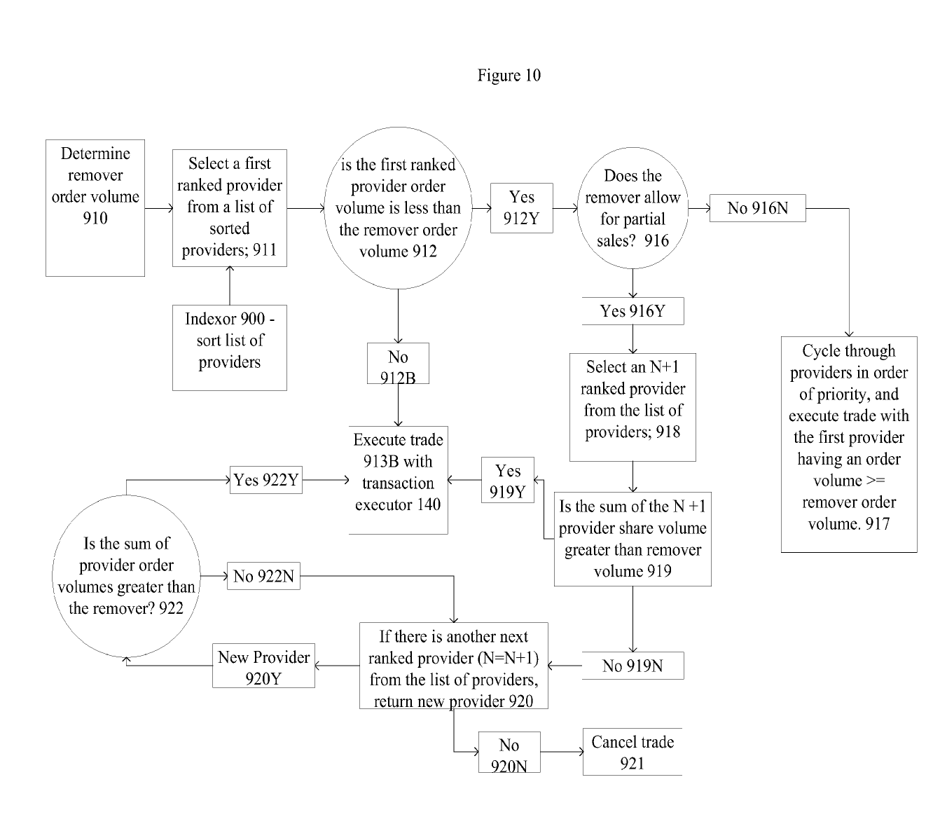

FIG. 10 shows a flow diagram of the provider selector.

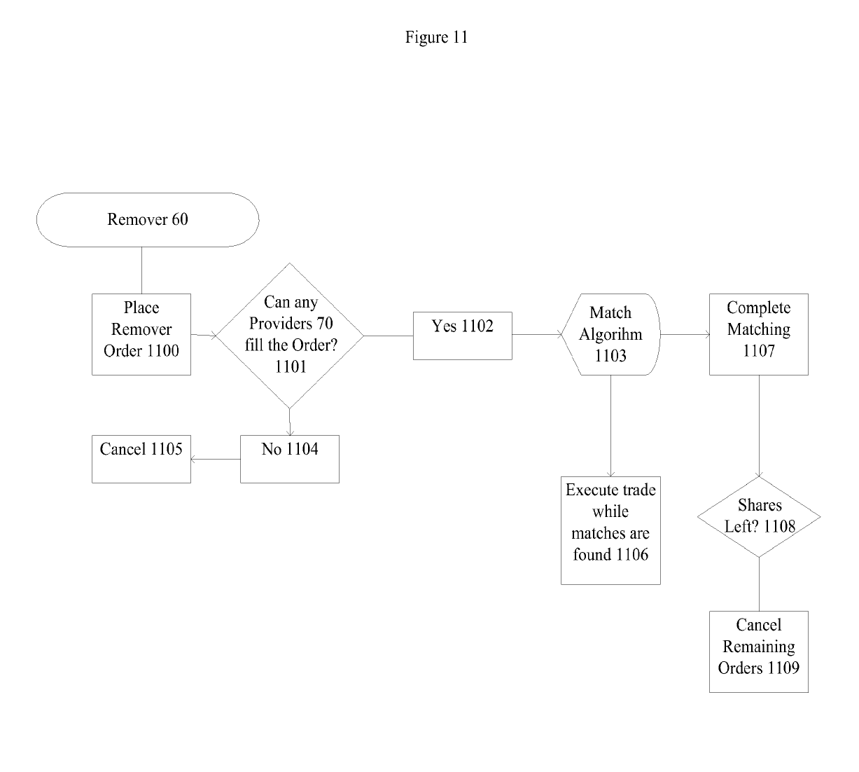

FIG. 11 shows a process flow of the platform.

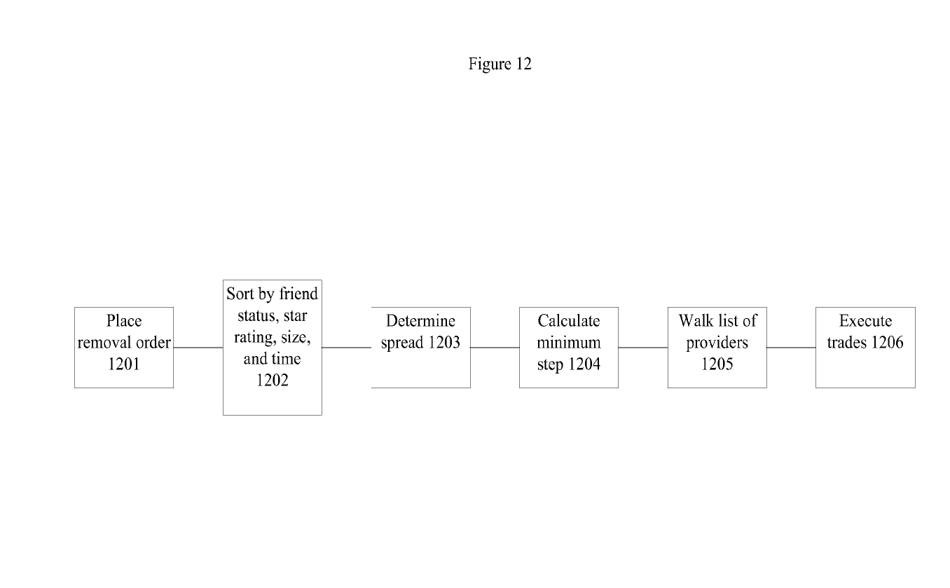

FIG. 12 shows a process flow of the match algorithm.

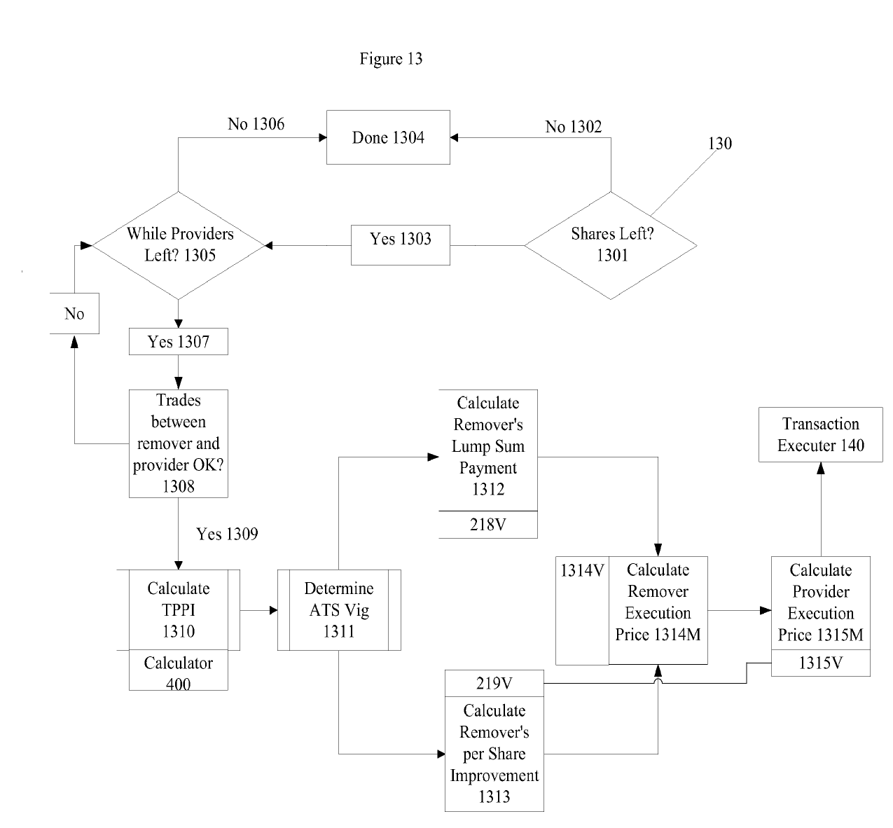

FIG. 13 shows a process flow of the selection algorithm.

### DETAILED DESCRIPTION

Configurations of the trading platform 100 may be implemented as software or specialized computer instructions stored on tangible computer readable storage media for causing a server to implement the software. The server (FIG. 2, 40) may have storage 44, system memory 42, a microprocessor 41, and network connectivity hardware 43. In a similar manner, certain embodiments may be implemented via a series of steps or processes executed by the server 40 via the microprocessors executing instructions stored in system memory. The present invention may also be embodied as a specially-designed computer which contains the software in memory and implements the instructions required by the software.

FIG. 1 shows a high level schematic diagram of a trading system 20. In an exemplary embodiment remover 60 and provider 70 each have access to a computer 20R and 20P (these may be simple terminal or specially design workstations, etc). Computer 20R may connect to the transaction platform via fix adaptor 21R and computer 20P may connect to the transaction platform via adaptor 21P. Both can be configured to receive orders, modifications and cancels from clients as well as send order acknowledgements, executions, cancel acknowledgements and modifications acknowledgements. Platform operator 61 may update, modify, monitor, and/or administer the transaction platform through the configuration module 22 using computer 20O. A drop adaptor 23 is configured to provide order, cancel and execution details to clients and internal components as needed. The adaptor 23 also outputs executions to the trade reporting module 24, to the clearing module 25, and to the risk module 26. The trade reporting module 24 is configured to send executions to the TRF (Trade Reporting Facility). The clearing module 25 is configured to send executions for settlement. The risk module 26 is configured to process executions and cancels to watch for abnormal activity from any client and ensure all clients are acting within their risk limits.

FIG. 2 shows an exemplary embodiment of a client server model. As it relates to FIG. 1, 20R, 20P, and 20O could be clients and the trading platform 100 may be powered by server 40. The client can contain computer parts like processor 31, memory 32, network equipment 33, storage 34, and a display 35. It may be connected 36 to the server 40 also containing a processor 41, memory 42, network equipment 43, and storage 44. It is contemplated that the server will contain specialized hardware to provide improved execution of the transaction platform 100.

As shown in FIG. 6, a trading platform 100 may contain a community rating calculator 110, rating module 120, provider selector 130, a trade executor 140, user interface 200, price calculator 400, and indexor 900. In one configuration, an article of tangible computer readable storage media is provided. That article (such as an optical disk or a hard drive) may contain software for causing a processor in the server 40 to implement an alternative trading system or platform 100. This platform 100 may be configured to allow a liquidity remover 60 to place an order for the purchase or sale of a security or other commodity. The platform may be configured to allow the order to be fulfilled by one or more liquidity providers. The platform may contain a number of modules, which may be objects, constructs, or routines programmed in the software to cause the microprocessor to implement certain steps. The platform may be used by users, who may or may not be members. Members are registered users who are a provider, remover, or both 75 (see FIG. 3).

As shown in FIG. 4, the trading platform 100 may contain an interface 200 (FIG. 4) that members 55 (liquidity removers 60 or liquidity providers 70) can access to indicate a willingness to trade a given security. The illustration shown in FIG. 4 is an exemplary screen that a remover might see. Initially, a remover will fill in the remover name 201V (which may be an ID or autofilled upon login), a security name 211V, and a number of shares 212V. When these values are entered by the users, the respective modules (201M, 211M, and 212M) may send these values to the price calculator 400 (of FIG. 6). Interface 200 may contain a number of additional order values the user can input such a Good Until Cancel value 217V or an All or None value 216V. Modules 216M and 217M would send the related information from these fields to the remover price calculator. NBBO price 213V may display the national best bid and the national best offer. The difference between the two (the tick or spread) may also be displayed. Module 213M may determine NBBO through contact with price reporting agencies. In some configurations, the remover may also set a lump sum payment 218V and per share price improvement 219V. (Processes 1312 and 1313 of FIG. 9 may determine these two values respectively.) These may be input as percentages, and also may be stored for the remover in the remover preferences accessed through pushing the remover configurator button 700. The sum of 218V and 219V may be determined by total potential price improvement module 220M, but the value shown (the total potential price improvement TPPI 220V) may depend on the remover's order size, timing, and relationship with the providers selling the security. The remover price calculator takes these factors into account (the process is spelled out below), and determines the TPPI, which is displayed in 220V and 220P. The ATS_VIG Fee and provider fee are explained with reference to FIG. 5.

Providers may also use an interface 250 (FIG. 5) to upload to the platform a list of their securities, a number of shares they are willing to execute, and a price. Thus the interface 250, may comprise a provider name field 251V, multiple fields for inputting security names 261V and number of shares 262V. Modules 251M, 261M, and 262M may upload this information to the platform 100. The provider may specify a particular provider fee (223V) for providing this security, the fee may be a function of the total notional purchased (shares*price), a function of the ATS_VIG fee, no fee, a flat fee, or percentage of the notional (223P). This fee may be sent to the platform via module 223M. The ATS_VIG fee (or more simply ATS Fee) is the fee the platform charges the provider and remover to execute the trade. In some configurations, the remover will pay this fee, and in other the provider pays the fee. In some configurations, both the remover and the provider pay the ATS_Vig fee. The ATS_VIG percentage (221P) may be set by the platform 100, and the value of the fee (221V) may be generated by the platform once the security and volume are added. The fee (221V) may be updated by the ATS_VIG module 221M as the price of the stock changes (for those ATS_Vig Fees based on the price.) ATS_VIG may be a percent of total potential price improvement the remover obtains through using the platform, and thus the ATS_VIG value might not be determinable under the remover purchasing or selling the security is determined. The provider can enter its configuration details via the provider configurator 800.

Referring now to FIGS. 7 and 8, the provider configurator 700 and/or remover configurator 800 (may take the form of a window or dialog box that allows users to specify the certain aspects of the trading relationship with trading counter parties. For example, the provider configurator 700 may contain a categorized remover interaction selector 710 (see FIG. 7) including sub selections of algorithmic traders 716, high frequency traders 717, retail customers 718, and unclassified traders 719, etc. The provider configurator 700 for a liquidity provider 70 may also display the following trading options: the rating of the remover by the provider 720; remover selection tool 725 the community rating of the remover 730, which can be calculated via a community rating calculator 110 executed by the platform 100; a friend only filter 740 that allows trades with friends only, and a list 750 configured to specify whether the counterparty it is viewing is a friend or preferred trading partner. Additionally, a remain anonymous 760 option and a friend request option 770 may be provided.

The remover configurator 800 (FIG. 8) may contain the following options that a remover can modify: a friend filter 810; categories of counterparties it desires to interact with 815 (such as algorithmic traders 816, high frequency traders 817, retail customers 818, unclassified traders 819, etc.), a list 820 of counterparties with whom it is willing (or unwilling) to trade, and an option to remain anonymous 825. Information displayed or entered into the provider configurator 700 or remover configurator 800 may be stored and accessed by the platform 100 in memory, computer readable storage, or through a remote or local database.

Looking now at FIG. 6 and FIG. 7, the platform may provide a rating module 120 configured to determine a remover rating. Provider may rate removers individually (through the individual rating module 720) and an average remover rating may be determined through a community rating module 730. The individual rating module 720 can provide members an interface to allow a member to rate other removers or providers. For example, a provider may provide a 1-5 star individual rating of a particular remover based on reputation or past experience. The rating module may also contain a community calculator that calculates a community rating for a given user. The member using the rating module 120 can use it to select an individual rating for another member. The individual rating module 720 may take the form of a series of hollow stars and accept a mouse click indicating how many stars out of five the user would like to establish for the given member. The rating module 120 may also interact with the community rating module 730 configured to calculate a community rating for a given member based on individual ratings the member has received. The community rating module 730 may average all the individual ratings, select a median value, or use other techniques such as weighted averages or standard deviations to determine the community rating. In terms of actually displaying the individual and community ratings of a particular member, the rating module 120 may contain an output function for delivering the results of the rating to the provider configurator 700.

The indexor 900 (of FIGS. 5 and 9) may comprise instructions to allow it sort a list of providers existing inside of the provider database stored and accessed by the platform. The sorting method and algorithm will vary depending on the configuration, but it may consider sorting criteria such as whether a remover is designated as a friend by the provider, the individual rating of the remover as established by the provider, how many shares the provider is willing to provide, whether provider charges a fee to sell the securities, price above or below the national best offer, whether the provider covers all or a part of the ATS_VIG (if applicable), and timing associated with when the provider made the shares available. The indexor 900 (FIG. 9) can implement a number of sorting algorithms based on which sort criteria applicable, and apply a sort precedence to allow for sorting by multiple criteria. In some configurations, the indexor will sort the providers that provide a particular remover the best purchase price. As an example, indexor can place providers that are friends or preferred trading partners with a particular remover first in the list (element 901). This would essentially create two groups of providers, preferred and nonpreferred trading partners 902 and 903. To sort the providers in each group, the indexor can consider the individual rating the particular provider assigned the remover, and place higher rated removers first in each bucket (element 904). If there are any ties at that point (e.g. two preferred trading partners each having a rating of 4 stars), the indexor could sequence the tied providers by share volume offered 905, community rating 906, and/or time of offer 907.

Still referring to FIG. 6, the indexor is responsible for generating a sorted list of providers, and takes as inputs the ID of the remover 201V, the security name 211V, the number of shares 212V, and other purchase information the remover might set (like All or None.) The database of providers 901 is generated through the provider's interaction with the interface 250 and the provider configurator. As provider's fill in their trading preferences and what securities and share amounts they are willing to trade, the platform populates a provider database 901. So, the indexor sorts the list of providers (the algorithms are explained below), and the provider selector 130 determine which provider(s) to match with the remover currently being processed. In other words, when a remover submits it's order, then the provider selector determines the remover/provider pairing. Various configurations of the indexor 900 may be run before and after the remover places the order to balances competing needs of precision matching and execution speed (it could take a few minutes to performs a complicated sort of a big list of providers), so this list may be partially sorted beforehand. Feedback technology may be used to determine what degree of sorting is needed so that removers obtain the best price without heavily sacrificing execution speed.

An exemplary selection algorithm may be executed by the provider selector as follows (see FIG. 10):
910: determine a remover order volume for the liquidity remover's transaction
911: select a first ranked provider from a list of sorted providers sorted by the indexor 900
912: determine if the first ranked provider order volume is less than the remover order volume? 912Y: Yes. Determine if the remover allows for partial fills (916). (In some configurations, the platform may determine if the provider allows for partial fills (and some configurations may allow both the remover and provider to disallow partial fills)) 916N: No. Cycle through the providers in order of priority, and execute trade with the first provider having an order volume >= to the remover order volume (917).
If 916 is Yes (916Y), select the Nth+1 provider (i.e. the next preferred provider) from the list of sorted providers (918).
919: Is the sum of the N, N+1 providers greater than the remover order volume? Yes. 919Y. Execute the trade using the transaction executor 140. No, 919N. Set N=N+1, and determine whether there is an N+1 provider from the list of providers. Return the results (920).
If 920 returns null, indicating there are no more providers (920N), cancel the trade 921.
If 920 returns the new provider indicating there are more providers (920Y), determine if the sum of the provider order volumes is greater than the remover order volume 922.
If 922 returns yes (922Y), execute trade 913B with the transaction executor 140.
If 922 returns no (922N), set N=N+1, and determine whether there is another providers (920).
Steps 920 and 922 cycle until the list of providers is exhausted or until the remover's share volume is satisfied by a sum of the providers' share volume.

As with many computer algorithms, there are multiple ways to program them, and the algorithm above and the one shown in FIG. 10 are exemplary only. A more general version of this type of algorithm is shown in FIG. 11. That algorithm includes

1. Check if any providers can fill a remover's order 1101;

2. If yes 1102, execute match algorithm 1103; else 1104 cancel remover's order 1105;

3. Execute trade while matches are found 1106;

4. Complete matching 1107;

5. Shares left 1108?

6. Cancel remaining orders 1109.

The match algorithm may be implemented as explained above with reference to FIG. 9, but another implementation of the match algorithm could be implemented as follows (FIG. 12):
1. Place remover order 1201;
2. Sort provider by friend status, star rating, size, and time 1202;
3. Calculate the spread 1203 utilizing the equation spread=National Best Offer (NBO)−National Best Bid (NBB);
4. Calculate minimum price steps 1204 utilizing the equation price step=spread*0.1;
5. Cycle through list of providers 1205;
6. Execute trades 1206.

FIG. 13 illustrates another embodiment of how server 40 executing the trading platform 100 can cycle through the list of providers. The provider selector 130 can start by checking if there are shares left in the remover's order 1301. If not 1302, the provider selector 130 ends 1304; if yes 1303, the provider selector checks if there are any providers left 1305. If not 1306, the provider selector ends 1304. If yes 1307, the provider selector determines 1308 whether either the provider or remover has elected not to trade with one another. If trades are not ok, 1309B, the provider selector 130 determines if there are any other provider left 1305. If trades are ok 1309, the provider selector references the remover price calculator 400 and determines (1310) the total potential price improvement.

TPPI is a discount from the NBBO the provider can provide to the remover to improve the price of the execution (ATS_VIG, explained shortly may be a percentage of the TPPI). In the example shown below in Table 1, TPPI may be determined as function of star rating*price step. If step equals 1, and the star rating ranges from 1-5 stars, each star becomes a plus multiplier, 1 star=1, 2 stars=2, 5 stars=5, etc. Other factors in addition to, or instead of the star rating could be used, such as friends selection, past orders, etc. Also a 1 price step per star isn't required, for example 1 star could=1, 2 stars=1.2, 3 stars=1.5, four stars=3, and five stars=5 (this would give a more significant benefit to remover for receiving a high provider rating.)

Referring to FIGS. 6 and 13, the provider selector 130 can obtain the ATS_VIG from 221P direct the platform fee calculator 430C to determine 1311 ATS Vig (platform fee 430V). ATS Vig=Max Pi*ATS Vig percent. ATS Vig percent is a value that can be set by operator controlling the trading platform 100. In Table 1 below, ATS Vig percent is set at 5% but other values can be used.

The selector 130 may then calculate 1312 the remover's lump sum price improvement payment using the remover lump sum payment calculator 435. This can be done by computing the difference between Max PI and ATS Vig, and multiplying the difference by the percent of lump sum payment. Percent of lump sum payment 218V is a value that the remover could set through the remover configurator or in the transaction poster 210. In the embodiment shown in FIG. 13, there are two ways in which the provider provides total potential price improvements (“TPPI”) to the remover: one is through lump sum payment 218V, and one is through price improvement which provides per share price improvement 219V on the execution. The sum of lump sum payment 218V and price improvement 219V constitute the total potential price improvement (TPPI) or economic benefit received by the remover.

As an example, let's assume the remover places an order for a $100,000 worth of securities, and the provider provides a TPPI of 5% price improvement, and there is a 0% platform fee (meaning an ATS_VIG fee of 0 and 0%). In this arrangement, the provider owes the remover $5,000 in total potential price improvement. The provider could pay a portion as a lump sum payment 218V and the remainder as a per share price improvement 219V. This technique may make it easier for the remover to pass savings to its customers and also retain some of the discount for itself. In the exemplary embodiment in Table 1, the remover sets 25% as a lump sum payment (e.g. 25% of $5,000) 218V and 75% as a per share price improvement 219V. To determine a total amount of benefit the provider is providing the remover in TPPI (220V), the total amount of shares the provider is providing would need to be multiplied by the price improvement per share 219V, and added to the lump sum payment 218V.

The lump sum payment 218V and the per share price improvement 219V (referring to FIG. 13), may be used to determine the remover's purchase price 1314V and the provider's sale price 1315V. Modules 1314M and 1315M determine the prices 1314V and 1315V respectively. To generate a purchase price and sale price, the calculator 400 may determine these prices so that modules 1314M and 1315M can display them. The calculator may determine a total potential price improvement the provider will offer based on its rating with the remover. Among the providers, some may rate a particular remover higher than others. A higher rating generally provides the remover a better price (in the previous example, number of stars times step) which is why the list or stack of providers available to transact with the remover may be sorted by the indexor 900 by rating so that the provider having the highest rating of remover is selected by the provider selector 130. This allows the provider selector 130 to match remover with the provider(s) that will provide the best price to the remover. As explained with reference to FIG. 10, sometimes the provider with the highest rating might not be selected, if for example, the remover wishes to purchase shares from one provider, and the highest rated provider doesn't have enough shares.

The total potential price improvement (TPPI, 220V in FIG. 4) may be for example 0.05 (or 5%) based on an exemplary 5 star or 10/10 rating. For the following example, assume the TPPI Percent is TPPI percent. The remover can specify through modules 218M and 219M what percent of that TPPI it wants as a lump sum payment (218V) and what percent of TPPI it wants as per share price improvement (219V). If the remover is 4815-1649-8962.1 purchasing X (e.g. 1200) shares at price Y (e.g. 50) and specifies 10% of TPPI as lump sum payment and 90% as per share price improvement, one can determine the purchase price for the remover (assuming no provider fee or ATS_VIG fee). The base price is just X*Y. The discount is TPPI*(1−0.1). This yields XY−X*Y*TTPI*(1−0.1)=$57,300. The remover will also receive a lump sum payment of X*Y*TTPI*0.1=$300. The per share price improvement being $2700 and the lump sum $300 for a total TTPI of $3000, 0.05% of X times Y. The amount of money the provider (assuming there is only one) would receive would be X (1200)*Y (50)−TPPI value (3,000) or $57,000. The $300 of lump sum payment may be delivered to the remover by the platform, or in some cases by the provider (in which case the provider would receive $57,300).

The above example assumes the platform fees (ATS_VIG) is 0%. In configurations employing an ATS fee, the remover, the provider, or a combination of both may be required to pay the fee. If the provider pays the fee and the ATS_VIG fee is 15%, the provider would just receive $57,300−X*Y*(1−0.15), or $57,300-$9,000 (Vig value)=$48,300. If the remover pays the fee, the total amount paid would be the same, $9,000, but for the convenience of the remover, this additional VIG fee may built into the purchase price, perhaps along with the discount. In some configurations, providers may be able specify what portion of the ATS_VIG fee it will pay, in which case providers paying more of the VIG might be ranked higher than higher ranked providers because the overall price to the remover may be less. In other configurations, the platform may set whether the remover or the provider pays the VIG Fee, and the Vig Fee may be a function of the total notional traded (notional equals shares*price). Larger orders may receive a discounted VIG fee percentage, because the overall fee remains same (compare 5% of a 100 vs. 2% of a 1000.) In still other configurations, such as the ones shown in the tables below, the ATS_VIG is a percentage of the TTPI.

The remover effective market price in 214V (as determined by the market price module 214M (FIG. 4)), may be different than Best Offer, because the TPPI, ATS_VIG, and Provider Fee changes the remover's effective market price (the price this remover must pay to purchase this amount of securities at this particular time.) Once the remover types in the name of the security into 211V, the number of shares into 212V, and an optional All or None 216V value or time a timing restraint, these values are sent to the platform server 100 along with the identity of the remover 201V. The platform server can determine which providers will provide this remover the best TPPI for the amount of shares requested (taking into consideration whether the remover selected All or None in 216V).

The price displayed by 214M, the remover's effective market price 214V, is calculated by the same process as explained above with respect to determining the total price, except the number of shares being traded is omitted from the calculation. Hence, Y−Y*TPPI*(1−0.1)=$47.75/share, reflecting a price per share improvement of $47.75. (Recall Y=50, and TPPI=0.05.) However, if the remover is to pay the ATS_VIG Fee, the formula for price per share becomes Y+Y*(1−ATS_VIG)−Y*TPPI*(1−0.1)=$55.25 (using a ATS_VIG of 15%). In this example, the remover is forced to pay a price higher than the best bid to buy the stock because the VIG Fee is so high (a transaction fee of 15% is much higher than current commercial platforms), but if the fee were lowed to 1.5% for example, the price to the remover becomes $48.50 a more reasonable price. The remover gets the stock at a price cheaper than the Best Bid, the platform owner is paid for the remover's use of the platform, and provider gets the sale of the stock at discount the provider had agreed to provide. As for the remaining lump sum payment amount 222V (FIG. 4), this amount would be calculated the same way as before, X*Y*TTPI*0.1−X*Y*ATS_VIG*0.1. The 0.1 reflecting 10% of the TTPI being earmarked for lump sum payment. If ATS_VIG is higher than TTPI, the lump sum payment will be a negative number, reflecting an amount the remover must pay to complete the transaction.

An alternate way that ATS_VIG may be utilized by the price calculator 400 may involve setting the ATS_VIG fee as a percentage of the TTPI. In such a configuration, the formula for price per share may be Y+Y*TPPI*(1−0.1)*ATS_VIG−Y*TPPI*(1−0.1)=Y+Y*TPPI*(1−0.1)*(ATS_VIG−1)=50+(50*0.05*0.9)*(−0.85)=48.0875. Notice how the same ATS_VIG percent (15% in this case) generates a very different price here, since it's a percent of the price improvement as opposed to the notional.

The following tables illustrate process flows for using the transaction platform 100. For Table 1, five firms have placed offers to sell the same security at all the NBO (these firms are thus “providers”).

TABLE 1

| Current Offer | | | | |
|---|---|---|---|---|
| Composition | | | | |
| NBB: 500.00 | | NBO: 500.10 | | Current Peg |
| Firm | Shares | Arrival Time | Action | Price |
| A | 1000 | 10:00 am | Sell | 500.1 |
| B | 500 | 9:59 am | Sell | 500.1 |
| C | 100 | 10:01 am | Sell | 500.1 |
| D | 100 | 10:02 am | Sell | 500.1 |
| E | 100 | 10:03 am | Sell | 500.1 |

In this example, a remover 60 (firm Z) places a order using the transaction poster 210 to buy 2000 shares of the same security. No buy price is specified, so the NBO (the market price) is assumed. The platform 100 may then determine the price that firm Z could get from the various providers. In this example none of the firms charge firm Z any extra fee for transaction.

TABLE 2

| | | | | Price |
|---|---|---|---|---|
| | Rating Of | | Payment | Improvement |
| Firm | Firm Z | Friend? | Firm Z | Firm Z |
| A | 4 | Yes | 0.00% | 100% |
| B | 5 | Yes | 0.00% | 100% |
| C | 5 | No | 0.00% | 100% |
| D | 1 | No | 0.00% | 100% |
| E | 0 | No | 0.00% | 100% |

Using the provider selector 130, the providers can be sorted into the transaction order based on friends status, rating, size, price, then time of order.

TABLE 3

| | Rating | | | Arrival |
|---|---|---|---|---|
| Firm | Of Z | Friend? | Shares | Time |
| B | 5 | Yes | 500 | 9:59 am |
| C | 5 | No | 100 | 10:01 am |
| A | 4 | Yes | 1000 | 10:00 am |
| D | 1 | No | 100 | 10:02 am |
| E | 0 | No | 100 | 10:03 am |

Next, the provider selector 130 can determine execution price using the price calculator 400. The execution price equals the best offer price minus the payment per share (provider transaction fee and ATS_VIG fees may be added in as well).

Table 4 illustrates the formulas used to generate examples A-C below. This table also provides the formulas used in some of the description above such as buy execution price 445V

TABLE 4

| | Column A | Column B | Column C |
|---|---|---|---|
| Row 1 | Market Data | Value | |
| Row 2 | Bid | 500.00 | |
| Row 3 | Offer | 500.10 | |
| Row 4 | | | |
| Row 5 | Static Data | | |
| Row 6 | ATS fee (% of Potential PI) | 0.05 | |
| Row 7 | % Remover wants in the form | 0.75 | |
| | of PI (price improvement) | | |
| Row 8 | % Remover wants in the form | 0.25 | |
| | of Lump Sum Payment | | |
| Row 9 | Providers Star Rating of the | 5 | |
| | Remover | | |
| Row 10 | | | |
| Row 11 | Calculated Values | Value | Formula |
| Row 12 | Min Tick | 0.01 | (B3 − B2) * 0.1 |
| Row 13 | Spread | 0.1 | B3 − B2 |
| Row 14 | Mid | 500.05 | (B3 + B2)/2 |
| Row 15 | TPPI based on rating | 0.05 | B9 * B12 |
| Row 16 | ATS Fee | 0.0025 | B15 * B6 |
| Row 17 | Remover Payment | 0.011875 | (B15 − B16) * |
| | | | B8 |
| Row 18 | Remover PI | 0.035625 | (B15 − B16) * |
| | | | B7 |
| Row 19 | Provider Fee | 0.011875 | B17 |
| Row 20 | Buy Exec Price | 500.064375 | B3 − B18 |
| Row 21 | Sell Exec Price | 500.035625 | B2 + B18 |
| Row 22 | Crossed Spread | 0.05 | B13 − B15 |

### Example A

### One Cent Wide Spread and a 5 Star Rating of the Remover

TABLE 5

| Market Data | |
|---|---|
| Bid | 10.00 |
| Offer | 10.01 |
| Static Data | |
| ATS Vig (% of Potential PI) | 0.05 |
| % Remover wants in the form | 0.75 |
| of price improvement PT | |
| % Remover wants in the form | 0.25 |
| of Lump Payment | |
| Providers Star Rating of the | 5 |
| Remover | |
| Calculated Values | |
| Min Tick | 0.001 |
| Spread | 0.01 |
| Mid | 10.005 |
| TPPI based on rating | 0.005 |
| ATS Vig | 0.00025 |
| Remover Payment | 0.0011875 |
| Remover PI | 0.0035625 |
| Provider Fee | 0.0011875 |
| Buy Exec Price | 10.0064375 |
| Sell Exec Price | 10.0035625 |
| Crossed Spread | 0.005 |

### Example 2

### One Cent Spread and a 0 Star Rating

TABLE 6

| Market Data | |
|---|---|
| Bid | 10.00 |
| Offer | 10.01 |
| Static Data | |
| ATS Vig (% of | 0.05 |
| Potential TPPI) | |
| % Remover wants | 0.75 |
| in the form of PI | |
| % Remover wants in | 0.25 |
| the form of Payment | |
| Providers Star Rating | 0 |
| of the Remover | |
| Calculated Values | |
| Min Tick | 0.001 |
| Spread | 0.01 |
| Mid | 10.005 |
| Max TPPI based on rating | 0 |
| ATS Vig | 0 |
| Remover Payment | 0 |
| Remover PI | 0 |
| Provider Fee | 0 |
| Buy Exec Price | 10.01 |
| Sell Exec Price | 10 |
| Crossed Spread | 0.01 |

### Example 3

### 5 Cent Wide Spread and a 4 Star Rating

TABLE 7

| Market Data | |
|---|---|
| Bid | 500.00 |
| Offer | 500.05 |
| Static Data | |
| ATS Vig (% of | 0.05 |
| Potential TPPI) | |
| % Remover wants in | 0.75 |
| the form of PI | |
| % Remover wants in | 0.25 |
| the form of Payment | |
| Providers Star Rating | 4 |
| of the Remover | |
| Calculated Values | |
| Min Tick | 0.005 |
| Spread | 0.05 |
| Mid | 500.025 |
| TPPI based on rating | 0.02 |
| ATS Vig | 0.001 |
| Remover Payment | 0.00475 |
| Remover PI | 0.01425 |
| Provider Fee | 0.00475 |
| Buy Exec Price | 500.03575 |
| Sell Exec Price | 500.01425 |
| Crossed Spread | 0.03 |

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. An alternative trading platform executed by a server, the platform configured to provide a liquidity remover and a liquidity provider with a platform in which they can trade securities, the platform being stored on tangible computer readable storage media and executable by a processor in the server; the platform comprising:
a. a rating module configured to accept a rating of the remover by a provider;
b. an indexor configured to generate a sorted list of liquidity providers offering a security of interest to the liquidity remover, the indexor further configured to utilize information from the rating module to generate the sorted list of liquidity providers;
c. a provider selector configured to select one or more providers from the list of providers to participate in a transaction with the remover; wherein the selected providers are determined to provide a better price to the remover than other providers; and
d. a price calculator configured to determine a buy price for the remover and a sell price for the provider.

2. The platform of claim 1, comprising an interface configured to receive information about the transaction including a security name, transaction price and amount of shares.

3. The platform of claim 2, wherein neither the remover nor the provider can specify a price of the security in which it is offering to buy or sell the security to any module in the platform, and the platform determines the buy price and sell price for the transaction.

4. The platform of claim 1, comprising an user interface containing a transaction poster that the liquidity provider can access to indicate a willingness to sell a particular commodity or group of commodities at a price determined by the platform.

5. The platform of claim 1, comprising a user interface containing a provider configurator having fields to enable a provider to specify: a remover's individual rating, a remover category, and an option to engage in anonymous transactions.

6. The platform of claim 1, comprising a database of users; each database entry containing a list of individual ratings a user has assigned to other users.

7. The platform of claim 1, wherein the rating module contains an individual rating module configured to generate an individual rating, said rating selector providing a graphic interface in which the provider can set an individual rating for the remover.

8. The platform of claim 1, wherein the rating module contains a community rating calculator that for calculating a community rating for the remover based on individual ratings the remover has received from other providers.

9. The platform of claim 1, wherein the rating module contains an individual rating display configured to display the individual rating of a given user, and a community rating display configured to display the community rating of a given user.

10. The platform of claim 5, wherein the provider configurator allows the provider to assign a friend designator to the remover.

11. The platform of claim 1, wherein the indexor is configured to sort the list of providers by determining whether a provider is designated as a friend, the individual rating of the remover as established by the provider, how many shares the provider can provide, and timing associated with when the provider made the shares available.

12. The platform of claim 1, wherein the indexor is configured to create a sorted list of providers by implementing a sort algorithm by sequencing the providers wherein:
a. providers that have indicated the remover is a friend are placed before providers which have not indicated the remover is a friend;
b. providers with a higher rating for the remover are placed before providers with a lower rating for the remover;
c. providers with a larger order volume are placed before providers with a lower order volume;
d. providers who indicated their willingness to provide liquidity for the commodity earlier are placed before providers who indicated their willingness to provide liquidity for the commodity later;
e. wherein the indexor sorts based on priority, and step (a) has priority over (b), step (b) has priority over step (c), and step (c) has priority over step (d).

13. The platform of claim 1, comprising a provider selector for determining which providers from the list of providers the trade executor will select for trading with the remover; the provider selector configured to implement the following selection algorithm:
a. determining a remover order volume for the liquidity remover's transaction;
b. obtaining a sorted list of providers, each provider in the list having a provider order volume; the provider order volume representing a number of shares of the security the provider has to trade;
c. selecting a first ranked provider from the list of providers;
d. if the first ranked provider order volume is less than the remover order volume, selecting a second ranked provider from the list of provider; else maintaining the selection of the first ranked provider;
e. if a sum of the selected provider's order volume is less than the remover's order volume, selecting a next ranked provider from the list of provider, and adding the next ranked provider order volume to the sum; else performing step (f);
f. instructing a trade executor to execute a trade between the remover and the selected providers; wherein the trade executor trades only as many shares as necessary to fulfill remover's order, and if the sum of the provider share volume is greater than the remover volume, the trade executor reducing the number of shares to trade from last selected provider in step (e); and
g. executing the trade at a price determined by the price calculator.

14. The platform of claim 1, wherein the price calculator configured to determine a remover effective price by:
a. determining a total potential price improvement;
b. determining a per share price improvement percentage; and
c. determining a per share price improvement value by multiplying per share price improvement percentage, total potential price improvement, number of shares, and share price.

15. The platform of claim 14, wherein the total potential price improvement depends on a rating assigned by the provider to the remover.

16. The platform of claim 14, wherein the platform is configured to charge an ATV_VIG that is a percentage of the total potential price improvement.

17. The platform of claim 14, wherein the platform sets the price equal to a value in between and inclusive of a reported national best bid and national best offer.

18. The platform of claim 14, wherein the platform is configured to provide the remover with a module to enter a lump sum payment percentage and module to enter a per share price improvement, wherein the price calculator is configured to:
a. determine a lump sum payment based on a total potential price improvement for the remover and the lump sum payment percentage;
b. determine a per share price improvement based on the total potential price improvement and the per share price improvement; and
c. determine the total potential price improvement based on a rating the provider assigned from the remover.

19. The platform of claim 18, wherein platform is configured to discount the total potential price improvement by an ATS_VIG fee.

20. The platform of claim 18, wherein the platform is configured to:
a. lower a displayed price per share purchase price based on the per share price improvement and the total potential price improvement; and
b. send the remover a payment based on the lump sum payment percentage and the total potential price improvement.

21. A method of providing a liquidity remover and a liquidity provider with a platform in which they can make transactions; the platform being stored in tangible computer readable storage media and executable by a processor in the server; the platform causing the server to:
a. provide the provider with an interface in which the provider can rate the remover;
b. generate a list of liquidity providers offering a security of interest to the remover using an indexor;
c. determine which provider or providers to join in a transaction with the remover using provider selector; and
d. determine an execution price for the current transaction between the remover and the provider using a price calculator.
